(19) United States
(12) Patent Application Publication
(10) Pub. No.: US 2017/0178241 A1
(43) Pub. Date: Jun. 22, 2017

(54) MULTIPLE ROUND CROWDFUNDING

(71) Applicant: International Business Machines Corporation, Armonk, NY (US)

(72) Inventors: Tamer E. Abuelsaad, Somers, NY (US); Werner Geyer, Newton, MA (US); Mary M. Keough, White Plains, NY (US); Michael Muller, Medford, MA (US); Tristan J. Ratchford, Boston, MA (US); John W. Rooney, New Fairfield, CT (US); Todd S. Soule, Cambridge, MA (US); John A. Wafer, Dublin (IE)

(21) Appl. No.: 15/197,198

(22) Filed: Jun. 29, 2016

Related U.S. Application Data
(63) Continuation of application No. 14/972,487, filed on Dec. 17, 2015.

(51) Int. Cl. G06Q 40/06; G06Q 20/36

(52) U.S. Cl. CPC G06Q 40/06; G06Q 20/36

(57) ABSTRACT

A software tool provides multiple round crowdfunding, maintaining investable amounts of investors within wallets, and projects having fundable amounts. The tool adds projects to a queue, and begins the multiple round process. In a round, the tool receives pledged amounts of the wallets towards the fundable projects within the queue. The tool moves each successfully funded project to a fully funded queue. After ending the round, the tool removes from the queue each fundable project for which the pledged amounts is less than its fundable amount and also less than a threshold for the project to advance to a next round, as determined by the tool. The tool ends the process when it determines that the maximum number of rounds has been reached, that the smallest fundable amount of any project remaining in the queue is greater than a remaining total of the wallets, or that the queue is empty.

### BACKGROUND

With the advent of the Internet, a unique approach to funding projects has been developed that did not exist prior to the Internet's ability to network multitudes of people across the globe together. This approach is Internet crowdfunding. In various crowdfunding web sites, a person who wishes to receive funding for his or her project posts the project, along with the amount of money needed. Users of the web site can then pledge amounts of money towards the project. If the pledged amounts from the users satisfy the amount listed by the project's owner, the project becomes funded, and the users pay the amount of money they pledged. Typically the owner of a project provides incentives at different levels of pledged amounts, to entice people to pledge money towards the project. Such incentives can be in the form of the product that is the subject of the project itself, for instance, discounts for the product, and so on.

### SUMMARY

An exemplary method for multiple round crowdfunding includes receiving, by a computing device, a list of projects. Each project has a fundable amount. The method includes receiving, by the computing device from investors, an investable amount of an investor wallet of each investor. The method includes adding, by the computing device, the projects to a queue of fundable projects. The method includes repeating the following until the computing device determines that a number of investing rounds is equal to a maximum number of investing rounds, the computing device determines that the fundable amount of the project remaining in the queue having a smallest fundable amount of any project remaining in the queue is greater than a remaining total of the investor wallets of the investors, or the computing device determines that the queue of fundable projects is empty. The computing device begins a new investing round, and receives pledged amounts of the investor wallets of the investors towards the fundable projects within the queue. The computing device moves each fundable project from the queue for which the pledged amounts of the investors the computing device has received towards the fundable project met the fundable amount of the fundable project, as determined by the computing device, to a fully funded queue. The computing device ends the new investing round, and after ending the new investing round, removes each fundable project from the queue for which the pledged amounts the computing device has received towards the fundable project is less than the fundable amount of the fundable project and less than a threshold for the fundable project to advance to a next investing round, as determined by the computing device.

An exemplary computer program product includes a computer readable storage medium having stored thereon program instructions executable by a computing device of an investor participating in multiple round crowdfunding to cause the computing device to perform the following. The computing device sends to a server computing device managing the multiple round crowdfunding an investable amount of an investor wallet of the investor. The computing device repeats the following until the computing device determines that the investor wallet of the investor has been depleted, or the server computing device sends an indication that no more investing rounds will be conducted. At a beginning of a new investing round, the computing device receives from the server computing device a list of fundable projects. Each fundable project has a fundable amount. While the new investing round is ongoing, the computing device sends to the server computing device a pledged amount for each fundable project that the investor has selected to fund. At an end of the new investing round, the computing device receives from the server computing device a status of each fundable project within the list as one of: successfully funded such that the fundable amount of the fundable project was met, and unsuccessfully funded such that the fundable amount of the fundable project was not met.

An exemplary system for multiple round crowdfunding includes a network adapter to communicatively connect with client computing devices of investors over a network. The system includes a processor, and a storage device storing program instructions executable by the processor to perform the following. The processor receives from the client computing devices over the network, an investable amount of an investor wallet of each investor, and adds a list of projects having fundable amounts to a queue of fundable projects. The processor repeats the following until the instructions determine that a number of investing rounds is equal to a maximum number of investing rounds, the instructions determined that the fundable amount of the project remaining in the queue having a smallest fundable amount of any project remaining in the queue is greater than a remaining total of the investor wallets of the investors, or the instructions determine that the queue of fundable projects is empty. The processor begins an investing round, and receives from the client computing devices over the network, pledged amounts of the investor wallets of the investors towards the fundable projects within the queue. The processor moves each fundable project from the queue for which the pledged amounts of the investors towards the fundable project met the fundable amount of the fundable project to a fully funded queue, and ends the investing round. After ending the investing round, the processor removes each fundable project from the queue for which the pledged amounts towards the fundable project is less than the fundable amount of the fundable project and less than a threshold for the fundable project to advance to a next investing round.

### BRIEF DESCRIPTION OF THE DRAWINGS

FIG. 1 is a flowchart of an exemplary method for multiple round crowdfunding.

FIGS. 2A and 2B are diagrams of an exemplary multiple round crowdfunding performed in accordance with FIG. 1.

FIG. 3 is a diagram of an exemplary system for multiple round crowdfunding.

FIG. 4 is a flowchart of an exemplary method for multiple round crowdfunding from the perspective of the client computing device of an investor.

### DETAILED DESCRIPTION

Crowdfunding is a way for disparate users across the globe to fund projects over the Internet or over an organizational Intranet. Existing crowdfunding approaches are single round consumer crowdfunding. A consumer in this sense is a person or entity that does not reveal the total amount that he or she has available to fund projects, in that this amount is not shared with the crowdfunding platform. Crowdfunding for a particular project occurs in one round at a time. For example, on a typical crowdfunding web site, projects are constantly posted asynchronously. When a new project is posted, it has a limited amount of time to receive funding. If the project is unsuccessful in receiving the desired amount of funding, the project becomes expired. The project's owner has to relist the project in order to start the crowdfunding process over again.

Disclosed herein, by comparison, is a software tool implemented via a computing device to enable multiple round crowdfunding, such as multiple round enterprise crowdfunding. An enterprise in this sense is a person or entity that shares the total amount that he or she has available to fund to projects. Furthermore, crowdfunding for a number of projects occurs over multiple rounds. In each round, the software tool permits investors, such as enterprise investors, to pledge amounts to desired projects. The software tool employs logic to move successfully funded projects to a fully funded queue so that they cannot be funded further in the next round. Furthermore, the software tool employs logic to remove unsuccessfully funded projects that have not received even a threshold amount of pledges, at an end of a round before the next round occurs. Thus, the software tool has logic that encodes a multiple round crowdfunding approach to filter out the available projects that can be funded to those that received some threshold level of interest in a prior round. The software tools ends the process (i.e., no more rounds occur) when the tool determines that a predetermined maximum number of rounds has been reached, that there are no more fundable projects left, or that the smallest requested funding amount of any remaining project is greater than the total remaining amount that the investors as a whole have left to pledge.

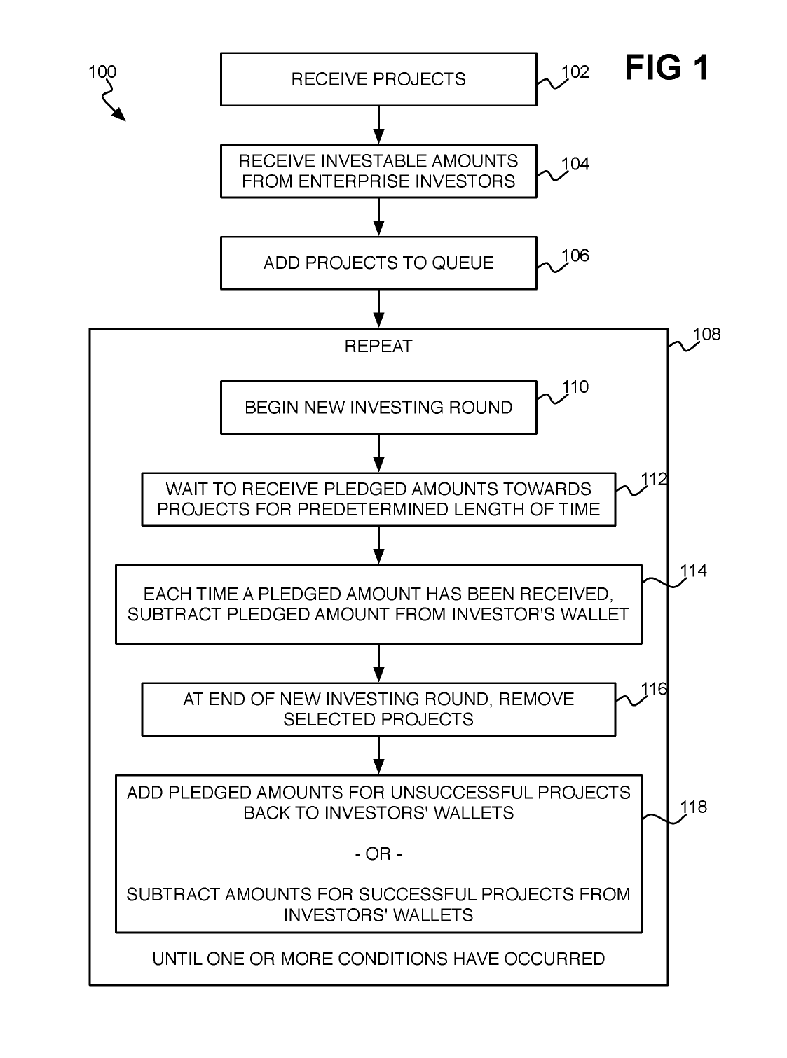

FIG. 1 shows an exemplary method 100 for multiple round crowdfunding. A software tool implemented via a computing device performs the method 100. The software tool receives a list of projects that each have a fundable amount (102). For example, the software tool may operate a web site to permit users interested in receiving funding to post projects. A project can be a product, a service, or another type of project. The software tool's logic treats the fundable amount of a project as the amount that the owner of the project has set as the amount necessary to be pledged to be considered successful. That is, the logic of the software tool treats the fundable amount of a project as the amount that the owner needs to begin developing the project. If the software tool does not receive pledges equal to or greater than the fundable amount, then the software tool determines that the project is unsuccessfully funded, whereas if the tool receives pledges equal to or greater than the fundable amount, then the software tool determines that the project is successfully funded.

It is noted that the terminology “amount” used herein is with reference to a currency, but the currency may or may not be a real currency. For example, in one implementation, the software tool may use currency may be in the form of US dollars, euros, bitcoin, and so on. By comparison, in another implementation, the tool may use currency in the form of credits, points, etc., which are not real currencies per se.

The list of projects that the software tool receives in part 102 includes those projects for which the tool will perform multiple rounds of crowdfunding in the remainder of the method 100. Therefore, the software tool may ensure that the projects of the list are similar in subject matter. For example, the software tool may ensure that the projects all pertain to features to be added to particular software or hardware. In this respect, the software tool can be used within an organization, such as a corporation, as a way to allocate scarce development resources among projects within the corporation itself.

The computing device (i.e., software tool) further receives from investors an investable amount of an investor wallet each investor (104). The software tool may receive investable amounts of the investor wallets from client computing devices of the investors in one implementation. The software tool stores the investable amount of each investor as the maximum amount of money that the tool considers the investor to be willing to commit to projects within the tool's current performance of the multiple round crowdfunding of the method 100. The software tool stores the investable amount in a data structure referred to herein as an investor wallet. The term wallet is thus used herein to denote the data structure in which the tool stores the investable amount that a corresponding investor has to fund projects, and does not denote an actual physical wallet, for instance. That the computing device knows and maintains the investable amount within the investor wallet of each investor in this respect is a unique distinction of the crowdfunding described herein as compared to conventional crowdfunding.

The investors participating in the multiple round crowdfunding afforded by the software tool may be at arm's length from one another, or may be part of the same organization. As an example of the former, the investors may be individual users or institutions scattered throughout the world, and who may not be affiliated with one another but for their usage of the software tool in the tool's performance of the crowdfunding method 100. As an example of the latter, the investors may be employees of the same entity, such as the same corporation, who each have been apportioned a certain amount of budgetary dollars or other currency to effectively vote on, using the software tool, which projects of the entity are to be provided funding in the next budgetary cycle.

The software tool adds the projects of the list received in part 102 to a queue (106). The software tool then has logic to perform the following process is then repeated until one or more conditions have occurred (108). The software tool starts a new investing round (110). While this investing round is ongoing, the tool waits a predetermined length of time to receive pledged amounts from the investors towards the fundable projects within the queue (112). The software tool thus continues the investing round continues until the tool detects that the length of time has elapsed, at which time the software tool ends the investing round.

In one implementation, each time the software tool receives a pledged amount from an investor, the computing device (i.e., the software tool) subtracts this pledged amount from the investor's investor wallet as part of its logic to effect multiple-round crowdsourcing (114). Once the software tool determines that the investable amount within the investor wallet of an investor has reached zero, the software tool prohibits the investor from pledging any further amounts towards other projects. The software tool permits each investor to pledge different amounts to different projects within an investing round. The software tool permits different investors to pledge different amounts to the same project. The software tool may not receive any pledged amounts from the investors for some projects.

After the software tool ends the new investing round, as part of the logic to effect multiple-round crowdsourcing the software tool removes certain projects from the queue (116). First, the software tool via its logic moves successfully funded projects from the queue to a fully funded queue. A successfully funded project is a fundable project for which the tool has received pledged amounts from the investors as a whole equal to or greater than the project's fundable amount, as determined by the software tool. It is said, therefore, that the software tool determines that the fundable amount of such a project has been met, or satisfied.

It is noted that in another implementation, the software tool moves successfully funded projects from the queue to the fully funded queue immediately upon the software tool having received pledged amounts equal to or greater than their fundable amounts, as determined by the software tool. That is, in such an implementation, the computing device (i.e., the software tool) does not wait until the tool ends the round before moving successfully funded projects from the queue. Therefore, once the software tool has determined that a project has been successfully funded, for the remaining duration of the round in question the software tool prohibits the project from receiving further pledged amounts.

Second, the software tool removes unsuccessfully funded projects that received the least interest from the queue, as determined by the tool's logic. An unsuccessfully funded project is a fundable project for which the software tool has not received pledged amounts from the investors as a whole equal to or greater than the project's fundable amount, as determined by the software tool. However, the software tool does not remove all unsuccessfully funded projects from the queue, but rather just those that the tool innovatively determines have received the least interest from the investors. In particular, the software tool's logic considers a threshold amount of pledged funding that corresponds to sufficient interest for a project. If the software tool, receives pledged amounts for a project less than this threshold, then the tool removes the project from the queue. If the software tool receives pledged amounts for a project greater than this threshold, then the tool permits the project to remain in the queue (such that the tool advances the project to the next round), even though the project was not successfully funded.

Third, the software tool has logic to remove unsuccessfully funded projects that are impossible for the tool to fund in a next round of investing from the queue. The software tool's logic determines that such a project has a fundable amount that is greater than the remaining total of the investor wallets of the investors. For example, as a whole, the software tool may have data indicating that investors have $10,000 to invest. If the software tool has determined that the investors as a whole successfully funded $9,000 worth of projects, then the software tool's logic determines that $1,000 is left to invest in the next round. As such, the tool's logic can conclude that, even if the tool receives for an unsuccessfully funded project pledges greater than a threshold (say, $500), if the tool determines that the project's fundable amount is greater than $1,000, then the tool concludes via its logic that it is impossible for the tool to fund the project in the next investing round, since the software tool's data indicates that there is just $1,000 left to invest.

Depending on the implementation, the computing device (i.e., the software tool) adds pledged amounts for unsuccessfully funded projects back to the investor wallets of the investors in question, or subtracts the pledged amounts for successfully funded projects from the investor wallets of the investor in question (118). The software tool performs the former in an implementation in which the tool performed part 114. That is, if the software tool reduces the investor wallet of an investor by a pledged amount as soon as the software tool receives a pledge from an investor, then if the tool determines that the project in question is unsuccessful, the tool returns the pledged amount to the investor's wallet. However, the software tool performs the latter in an implementation in which the tool did not perform part 114—that is, for each successfully funded project that an investor funded, the tool subtracts the amount that the investor pledged from the investor's wallet.

The software tool repeats the process of part 108 that has been described for another investing round. In each round, the software tool reduces the projects that the tool permits the investors to pledge funds against by removing successfully funded projects, the unsuccessfully funded projects for which the tool received the least interest in the prior round, and the unsuccessfully funded projects that the tool has determined have fundable amounts which are impossible to meet in the next round. That the software tools removes unsuccessfully funded projects for which the tool received the least interest in the prior round from the projects for which the tool can receive pledges in the next round is particularly innovative, ensuring that the software tool and thus the computing device focuses the investors' attention on those projects that were popular in the prior round, but not sufficiently popular to receive complete funding.

The software tool ends the process of part 108—that is, the tool conducts no more investing rounds—when the tool detects that one or more of three conditions have occurred. The first condition is that the software tool determines that the number of investing rounds that the tool has performed is equal to the maximum number permitted. This ensures that when the software tool detects that the investors do not wish to fund any further projects, even though the tool determines that there are still projects left in the queue and that the investors have investable amounts within investor wallets to pledge, the tool does not continue the process of part 108 indefinitely. The second condition is that the software tool determines that there are no more projects left in the queue, which means that there are no projects for which the tool can received pledged amounts of money from investors. The third condition is that the software tool determines that the project in the queue that has the smallest fundable amount is greater than the remaining total of the investor wallets of all the investors, which means that it is impossible for the tool to receive funding for any project remaining in the queue.

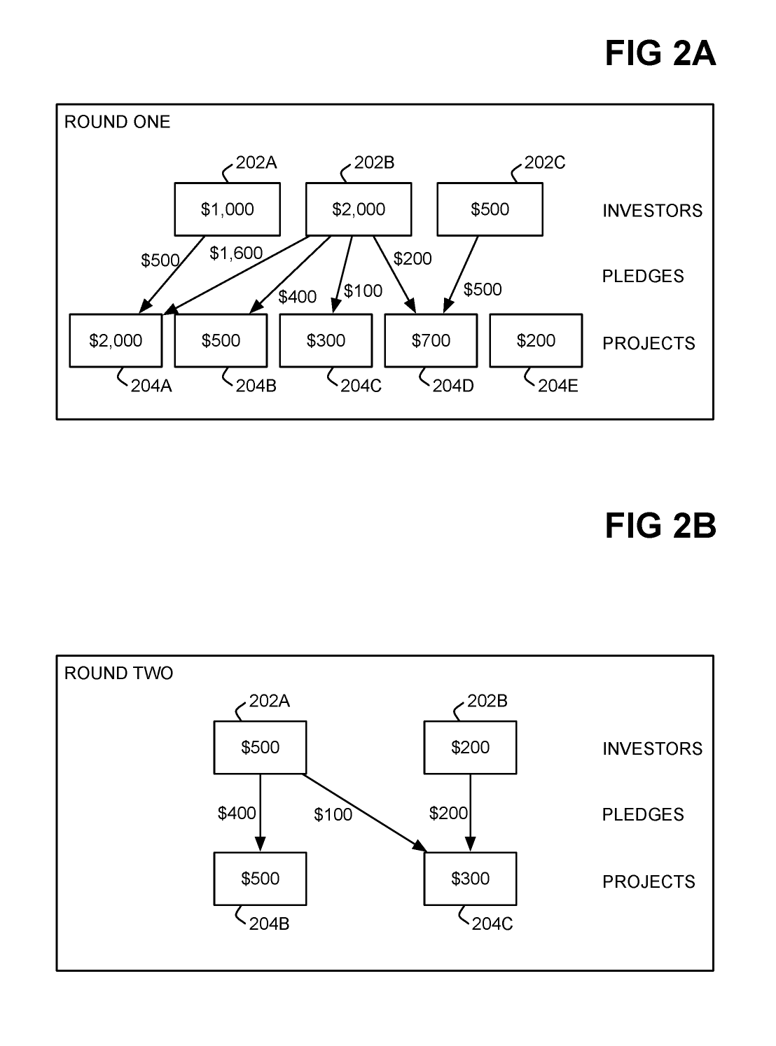

FIGS. 2A and 2B show an exemplary two round crowdfunding that the software tool performs in accordance with the method 100. There are three investors 202A, 202B, and 202C, who are collectively referred to as the investors 202. For these three inventors 202, the software tool maintains investor wallets including investable amounts of $1,000, $2,000, and $500, respectively, prior to the first round. The software tool stores data representing five projects 204A, 204B, 204C, 204D, and 204E, which are collectively referred to as the projects 204, and for which the tool stores fundable amounts of $2,000, $500, $300, $700, and $200. In the example of FIGS. 2A and 2B, the software tool maintains a threshold of pledged amounts by which the tool permits an unsuccessful project needs to advance to the next round at $100.

In the first round of FIG. 2A, the software tool receives from investor 202A a pledged just $500 of the $1,000 available, to the project 204A. The software tool receives from investor 202B a pledge of all of the $2,000 available: $1,600 to the project 204A, $100 to the project 204B, $100 to the project 204C, and $200 to the project 204D. The tool receives from investor 202C a pledge of $500 to the project 204D—i.e., all of the investable amount of the wallet that the software tool is maintaining for this investor.

Therefore, when the software tool concludes the first round of FIG. 2A, the tool determines that the project 204A has been successfully funded. Although the project 204A needed just $2,000, the software tool received $2,100 in pledged amounts for the project 204A, and therefore provides the entirety of the $2,100 pledged in this example to the project 204A. The software tool also determines that project 204D has been successfully funded, because the tool has received exactly the $700 for this project 204D that the project 204D needed. The software tool for each of the projects 204B and 204C received a pledged amount of $100, and thus the tool determines that the threshold has been satisfied for the tool to advance the projects 204B and 204C to the next round, even though the tool determined that the projects 204B and 204C were unsuccessfully funded in the first round. The software tool, by comparison, determined that for the project 204E it received no pledges, and therefore determines that the project 204E does not satisfy the threshold of $100 for the project 204E to advance to the next round.

When the software tool begins the second round of FIG. 2B, the tool determines that just two investors 202A and 202B remain. This is because the software tool detects that it had received from the investor 202C a pledge of $500 to the project 204D, which was successfully funded, such that the tool detects that the investor 202C has no more investable amount within the wallet that the tool maintains for the investor 202C to pledge. The software tool determines that the investor 202A has $500 remaining, because the tool's logic can assess that the tool had received from the investor 202A a pledge of $500 to the successfully funded project 204A. The software tool further determines that the investor 202B has $200 remaining, because the tool's logic assess that the tool has received from the investor 202B a pledge of $1,600 to the successfully funded project 204A and $200 to the successfully funded project 204D.

In the second round of FIG. 2B, the software tool does not permit pledges to be made to the projects 204A and 204D, because the tool has determined that they were successfully founded in the first round. The software tool does not permit pledges to be made to the project 204E because the tool determines for the project 204E the tool did not receive the threshold amount of pledges —$100—in the first round for the tool 204E to advance the project 204E to the second round. As such, the software tool advances just the projects 204B and 204C to the second round, because for each project the tool received at least the threshold amount of pledges even though the tool determined that they were unsuccessfully funded in the first round. Furthermore, the software tool's logic determines that both the projects 204B and 204C have fundable amounts ($500 and $300, respectively) that are not greater than the total amount of investable funds of the investors 202A and 202B, which is $700.

In the second round of FIG. 2B, the software tool receives from the investor 202A a pledge of $400 to the project 204B and a pledge of $100 to the project 204C. The tool receives from the investor 202B a pledge of $200 to the project 204C. At the end of the second round, then, the software tool determines that the project 204C has been successfully funded, and the logic of the tool determines that the investor 202B has no more investable funds left. The software tool therefore does not advance the project 204C to the next round. Although the tool received for the project 204B more than the threshold amount of pledges sufficient for the tool to advance this project 204B to the next round, the tool still does not advance the project 204B to the next round, because the tool determines that this project's fundable amount of $500 is greater than the total amount of investable funds of the investors 202A and 202B after the second round, which is the $400 of the investor 202A. Because the software tool determines that there are no projects for the tool to advance to a third round, the tool ends the multiple round crowdfunding after two rounds.

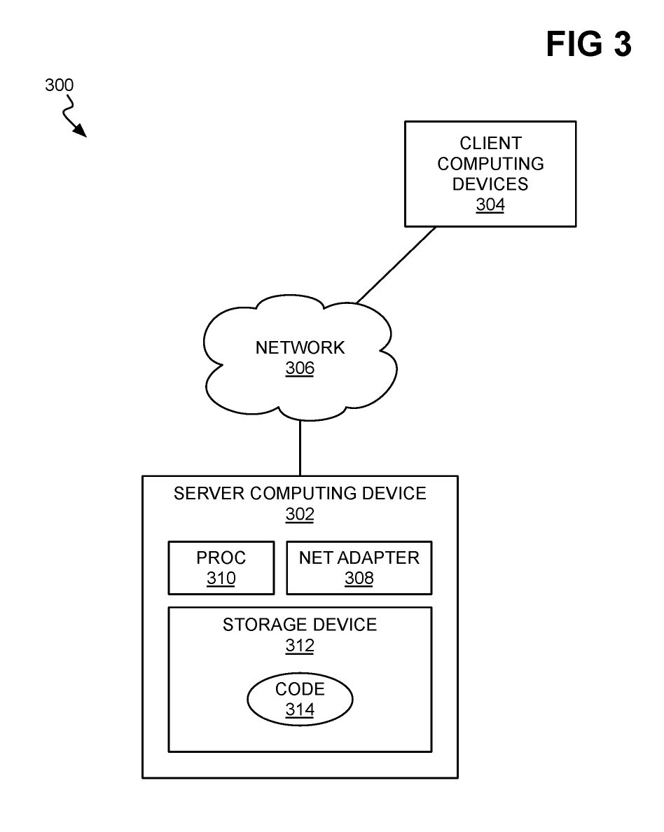

FIG. 3 shows an exemplary system 300 for multiple round crowdfunding. The system includes a server computing device 302 and client computing devices 304 that are communicatively connected to one another over a network 306. The client computing devices 304 are operated by the investors, and can be mobile computing devices like smartphones, computers like laptop and desktop computers, and so on. The network 306 can be or include the Internet, an intranet, an extranet, a local-area network (LAN), a wide-area network (WAN), a telephony network, and so on.

The server computing device 302 performs the method 100 that has been described. The server computing device 302 includes a network adapter 308 that permits the device 302 to connect to the network 306, and thus to communicatively connect to the client computing devices 304. The server computing device 302 includes a processor 310, and a storage device 312, such as memory and/or a hard disk drive, which stores computer-executable code 314. The processor 310 executes the code 314 to perform the method 100 that has been described. That is, the code 314 implements the software tool and its logic to realize the method 100 that has been described.

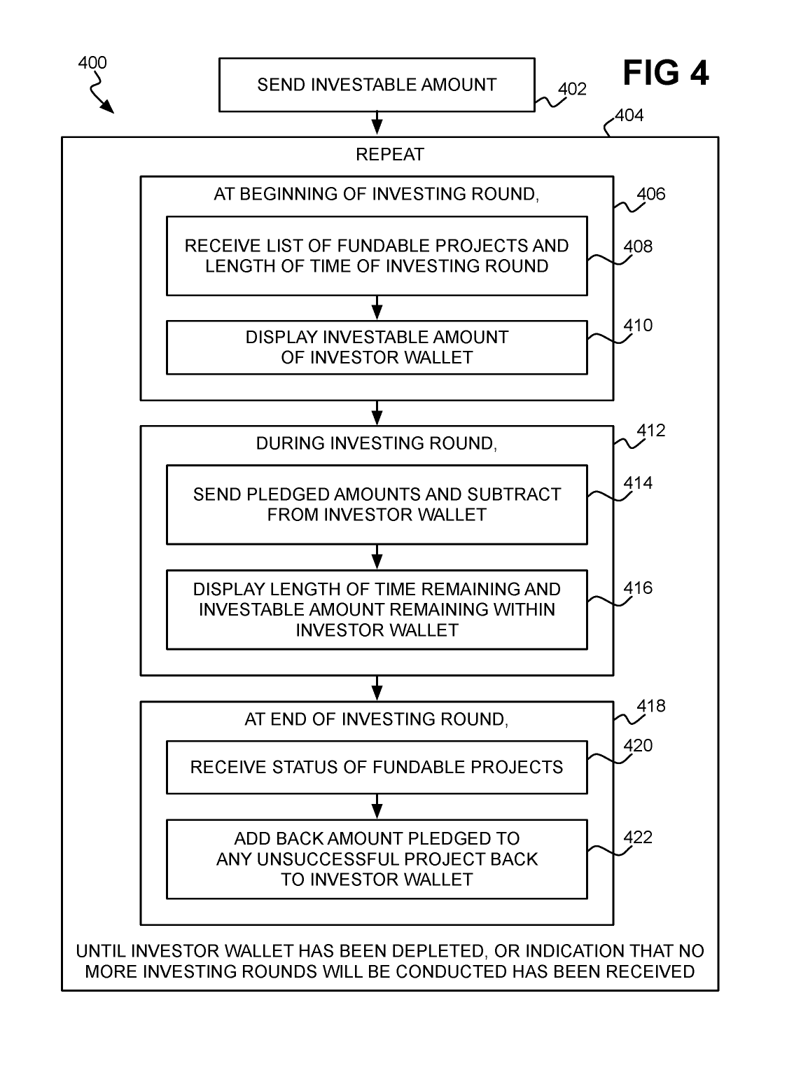

FIG. 4 shows an exemplary method 400 that a client computing device 304 performs in conjunction with the server computing device 302 performing the method 100. The client computing device 304 receives the investable amount within the investor wallet from its investor, and sends the investable amount of this wallet to the server computing device 302 (i.e., the software tool) (402). The client computing device 304 then repeats the following process (404).

At the beginning of an investing round (406), the client computing device 304 receives from the server computing device 302 (i.e., the software tool) the list of fundable projects to which the investor can pledge in the investing round, as well as the length of time the investing round will last (408). The client computing device 304 displays to the investor the investable amount that is available within the investor wallet to pledge (410). During the investing round (412), the client computing device 414 sends pledged amounts for the fundable projects as desired by the user, to the server computing device 302, and correspondingly subtracts the pledged amounts from the investable amount available within the investor wallet (414). The client computing device 414 further displays the length of time remaining as it counts down to the end of the investing round, and the investable amount remaining within the wallet as funds are pledged (416).

At the end of the investing round (418), the client computing device 304 can receive the status of the fundable projects from the server computing device 302 (i.e., the software tool), and displays the status of each (420). For example, the status can be for each fundable project whether the fundable project was successfully funded or not. For each unsuccessfully funded project, the client computing device 304 adds back the amount pledged by the investor, if any, to the investor wallet for the next investing round, if any occur (422).

The client computing device 304's performance of the process of part 404 ends when one or more conditions have occurred. First, regardless of whether further investment rounds may be performed by the server computing device 302, if client computing device 304 determines that the investor of the device 304 has depleted his or her investable funds, then the device 304 ends the process for this investor. Second, the client computing device 304 ends the process if the server computing device 302 sends an indication that no more investing rounds will be conducted.

The software tool implementation of multiple round crowdfunding described herein thus provides for a novel form of crowdfunding that was unavailable prior to the existence of the Internet. Rather than one multiple asynchronous individual investing round for each project, the software tool permits multiple synchronous investing rounds for groups of projects. Rather than crowdfunding being performed by consumer investors that have unknown investable funds or that do not share their investable funds, the software tool provides for crowdfunding in which the tool maintains and knows the amount of investable funds available by investors. By preventing unsuccessfully funded projects that have received little interest from investors from proceeding to the next round, the software tool reduces the available projects that can be funded in the next round, thus increasing the likelihood that the software tool will be able to permit a maximum number of projects to be successfully funded.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

We claim:

1. A method for multiple round crowdfunding, comprising:
receiving, by a computing device, a list of projects, each project having a fundable amount;
receiving, by the computing device from investors, an investable amount of an investor wallet of each investor;
adding, by the computing device, the projects to a queue of fundable projects;
repeating:
beginning a new investing round, by the computing device;
receiving, by the computing device, pledged amounts of the investor wallets of the investors towards the fundable projects within the queue;
moving, by the computing device, each fundable project from the queue for which the pledged amounts of the investors the computing device has received towards the fundable project met the fundable amount of the fundable project, as determined by the computing device, to a fully funded queue;
ending the new investing round, by the computing device;
after ending the new investing round, removing, by the computing device, each fundable project from the queue for which the pledged amounts the computing device has received towards the fundable project is less than the fundable amount of the fundable project and less than a threshold for the fundable project to advance to a next investing round, as determined by the computing device,
until one or more of:
the computing device determines that a number of investing rounds is equal to a maximum number of investing rounds;
the computing device determines that the fundable amount of the project remaining in the queue having a smallest fundable amount of any project remaining in the queue is greater than a remaining total of the investor wallets of the investors;
the computing device determines that the queue of fundable projects is empty.

2. The method of claim 1, wherein each fundable project for which the pledged amounts met the fundable amount of the fundable project and that the computing device has been moved from the queue to the fully funded queue is a fully and successfully funded project.

3. The method of claim 1, further comprising:
after ending the new investing round, removing, by the computing device, each fundable project from the queue for which the pledged amounts that the computing device received towards the fundable project is less than the fundable amount of the fundable project and for which the fundable amount is greater than the remaining total of the investor wallets of the investors, as determined by the computing device.

4. The method of claim 1, further comprising:
after beginning the new investing round, waiting, by the computing device, a length of time to receive the pledged amounts,
wherein the computing device ends the new investing round after the length of time has elapsed.

5. The method of claim 1, further comprising:
each time the computing device has received a pledged amount of the investor wallet of an investor towards a fundable project within the queue, subtracting, by the computing device, the pledged amount from the investor wallet of the investor,
wherein the computing device permits each investor to pledge amounts towards the fundable projects while the computing device determines that the investor wallet of the investor is greater than zero.

6. The method of claim 5, further comprising:
after ending the new investing round, for each investor, adding, by the computing device, the pledged amount received from the investor back to the investor wallet of the investor for any fundable project for which the pledged amounts of the investors did not meet the fundable amount of the fundable project, as determined by the computing device.

7. The method of claim 1, further comprising, after ending the new investing round:
for each fundable project for which the pledged amounts towards the fundable project exceeded the fundable amount of the fundable project, as determined by the computing device,
subtracting, by the computing device, the pledged amount of each investor towards the fundable project from the investor wallet of the investor.
